(19) United States
(12) Patent Application Publication
(10) Pub. No.: US 2005/0288841 A1
(43) Pub. Date: Dec. 29, 2005

(54) Stack selection reversing control for bale wagons

(75) Inventor: Robert L. Fackler, Ephrata, PA (US)

Correspondence Address: Martin Fruitman;CNH America LLC, Intellectual Property Dept., P.O. Box 1895, MS 641, New Holland, PA, 17557, US

(73) Assignee: CNH America LLC, New Holland, PA (US)

(21) Appl. No.: 10/877,409

(22) Filed: Jun. 25, 2004

(51) Int. Cl. G06F 19/00

(52) U.S. Cl. 701/50

(57) ABSTRACT

The apparatus is a stepping reversing control for automated bale wagons in which an individual stack pattern is selected from a list by stepping through the list in a single direction by use of a pushbutton. The reversing control measures the interval for which the pushbutton is activated and reverses the direction of the stepping if the time the pushbutton is held down exceeds a prescribed time. A second control selects values from the list and generates a smaller favorites list and automatically makes all selections from only the favorites list.

### BACKGROUND OF THE INVENTION

This invention deals generally with automatic bale wagons of the type adapted to pick up crop material bales in the field and automatically form stacks of these bales utilizing a variety of selected stacking patterns to form a stable, interlocked stack of bales.

Present day practices in crop harvesting involve the formation of bales of crop material such as hay or other crops into stacks for storage by using an automatic bale wagon. One type of bale wagon that has achieved wide spread commercial acceptance is the automatic bale wagon which uses three tables as illustrated and described in U.S. Pat. No. 4,203,695 issued to Edward J. Wynn et al.

Such bale wagons include a first table which receives bales from a bale loader or pick up device mounted on the bale wagon. The first table accumulates a predetermined number of bales with the bales being arranged in a row in a pattern determined by a computer on board the bale wagon. A second table receives the rows of bales from the first table and accumulates several such rows. This group of rows is commonly referred to as a “tier”. A third table or load bed then receives the tiers from the second table and accumulates these tiers to form a “stack” on the load bed.

Once the stack has been accumulated on the load bed, it may be unloaded by pivoting the load bed 90.degrees and depositing the stack on the ground or other surface so that the first tier of bales which was accumulated on the second table is now the lowermost tier of the stack on the ground surface. In order to enhance the stability of the stack, it is desirable to vary the arrangement of the tiers within the stack, and the on-board computer is used to control tier pattern selection and formation on the wagon and the formation of bales into a predetermined sequence of tier patterns to form a block for stacking.

In fact, most automated bale wagons provide a very large selection of stack patterns. A typical bale wagon with computer controlled stacking patterns comes with 30 factory set patterns, and the operator can add as many as 20 more patterns to the selection roster. This large number of patterns is available because of the several independent variables within the stacking process. It is possible to vary the side that is selected as the bottom of the bale for each rectangular prism shaped bale, the direction in which each bale is oriented, the number of bales in each row, the number of rows in each tier, and the number of tiers in each stack However, the difficulty with prior art bale wagons is that the pattern selection process can be very time consuming because the selection process used provides only sequential access through the very large roster to reach the various settings. That is, a single pushbutton or switch sequences through a list of all the choices in their preset order and then permits the operator to activate the one that has been selected. Thus, if the operator passes a desired selection, the entire list of as many as 50 choices must again be run through. Anyone who has set the time on a digital alarm clock knows the frustration on using such a system.

However, this is actually a conscious design decision because space limitations require a minimum number of control pushbuttons, and a multiple digit complex control device would have safety consequences. For instance, a numerical keyboard would result in the same well documented safety problems that result from cell phone use in automobiles. Instead, the many selections are grouped into commonly associated sets, but that does not completely solve the problem. If a desired change in pattern requires the selection of a pattern earlier on the list, most of the list must still be stepped through.

It would be very beneficial to have a pattern selection process that does not add another complex control, but reduces the time, effort, and frustration required to choose a desired pattern.

### SUMMARY OF THE INVENTION

The present invention solves the problem without the addition of any additional switches by a slight modification of the computer program that sequences the selection list at the activation of a switch. The prior art program moves the selection and the operator's display of the selection number up one numbered step each time the switch, usually a pushbutton, is activated. The preferred embodiment of the invention preserves that operator's action and the machine's response to it, but adds a subtle feature. If the pushbutton is merely held down for a length of time exceeding a preset limit, % of a second in the preferred embodiment, the direction of movement of the selection process reverses.

Thus, if the operator wants to select a pattern that is only two steps back down the list from the present setting, whereas it was previously required to cycle through as many as 48 steps, it is now only necessary to momentarily hold the selection pushbutton down and the computer selects the next lower setting instead of the next higher one. Then one more quick push of the pushbutton is all that is needed to complete the proper selection. The reversal action of the invention is programmed to take effect regardless of the existing direction of progression of the selections. This technique is particularly beneficial for automated bale wagons because the existing programs typically group the patterns by the number of tiers desired. Therefore, if an operator is, for instance, using only 8 tier stacks on a particular job, all 8 tier patterns are near each other on the list and, using the present invention, can be selected with little trouble regardless of their relative position on the list.

The present invention also includes another feature which is even more beneficial for the typical machine operator. It is using the computer memory function to set up a shorter list of pattern “favorites”, the patterns most used by the operator. Such a list can be any number of choices and in any order. In fact, if only one pattern is programmed into the favorites memory, all choices other than that one are effectively eliminated. Such a technique can be useful in eliminating the accidental change of stack pattern by an inadvertent push of the pushbutton.

For the preferred embodiment, the stacking controls and indicator panel on computer controlled bale wagons can easily be adapted for the programming and use of favorite patterns, so that no complex controls need to be added to the typical bale wagon. Thus, with the reprogramming of the on-board computer of typical bale wagons, the operator's action of pattern selection can be made faster and much easier.

### BRIEF DESCRIPTION OF THE DRAWINGS

FIG. 1 is a plan view of the control and indicator panel for stack control on the preferred embodiment of the invention.

FIG. 2 is a block diagram of the stack pattern progression reversal and favorites selection circuits of the preferred embodiment of the invention.

### DETAILED DESCRIPTION OF THE INVENTION

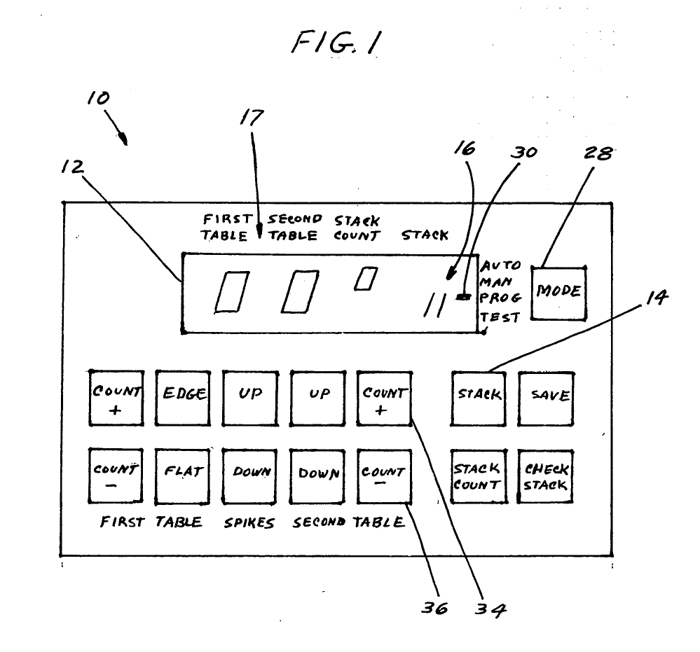

FIG. 1 is a plan view of the control and indicator panel 10 used for bale wagon stack control on the preferred embodiment of the invention. It should be appreciated that panel 10 deals with many functions that are not pertinent to this invention and therefore many controls will not be discussed. Indicator window 12 is used to show the status of many functions which are controlled by the various pushbuttons located below indicator window 12 through an on-board computer (not shown).

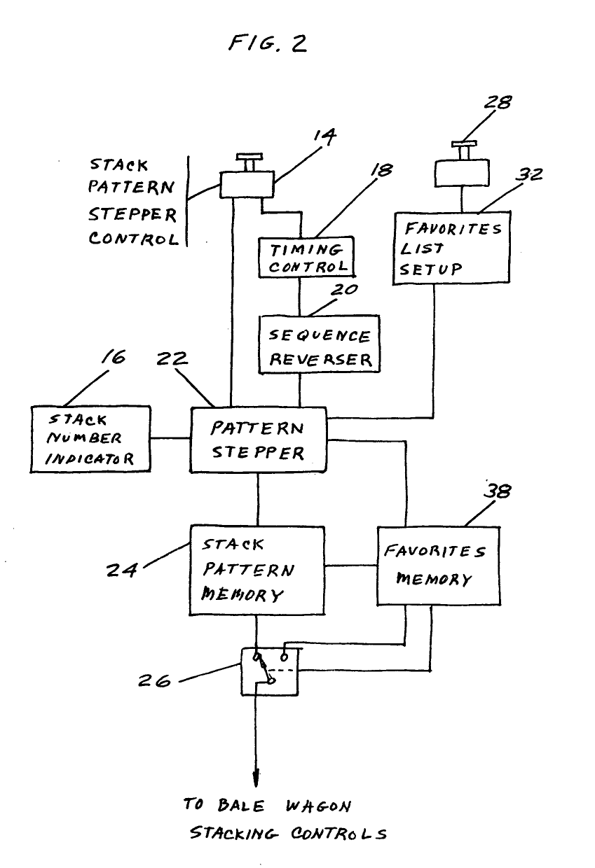

FIG. 2 is a block diagram of the stack pattern sequence reversal and favorites circuits of the preferred embodiment of the invention.

The following description can be followed on both FIG. 1 and FIG. 2 which use the same numbers to indicate the same components if appropriate.

Stack pushbutton 14 is conventionally used to sequence through the stack pattern list of the bale wagon in single pattern steps. Thus, in the conventional computer controlled bale wagon, each time stack pushbutton 14 is activated the pattern selection is stepped one position to the adjacent pattern selection with the next highest number, and the stack pattern number selected is shown at stack number location 16 on indicator window 12. Prior art controls have only that one direction, single step, selection operation.

In the preferred embodiment of the invention two functions are added to the controls without the use of any additional operator control devices. The first function is the ability to reverse the sequence through which the selection process moves. This reversal of the stepping sequence is accomplished by the operator quite simply by merely holding stack pushbutton 14 down longer than usual. The activation period of stack pushbutton 14 is checked by timing control 18 which activates sequence reverser 20 to reverse the stepping direction of pattern stepper 22. In the preferred embodiment the minimum required hold time for which timing control 18 is set is % of a second, but this time can be adjusted by reprogramming timing control 18. This sequence reversal operates regardless of the direction in which the sequence is currently progressing. Thus, the operator can easily move back and forth between several patterns that are near each other on the stack pattern roster, but perhaps the more important benefit is that the operator can easily reduce to one the 49 step sequence that would otherwise be required to select a new pattern just one step below the present pattern on the pattern roster.

Pattern stepper 22 selects each chosen pattern within stack pattern memory 24, and in normal operation this pattern in fed through favorites changeover circuit 26 to the bale wagon stacking controls (not shown) to perform the required mechanical operations to build the selected pattern.

The second new function added is a “favorites” list that generates a small roster of patterns which are most used by the particular machine operator and can be stepped through, in either direction, without the distraction of all the other choices on the main stack pattern list.

To accomplish the programming of the favorites list the operator pushes mode pushbutton 28 which moves mode indicator 30 one position downward for every push of pushbutton 28. Since mode indicator is usually positioned at the topmost position “AUTO” for automatic operation, mode pushbutton 28 is activated twice to move mode indicator 30 to “PROG” to activate favorites list setup program 32. This permits the operator to use count+pushbutton 34 or count—pushbutton 36 to move through the numerical list until the desired pattern number is indicated at numerical indicator location 17. Then the operator pushes stack pushbutton 14 to place that selected pattern in favorites memory 38. This action is repeated for every selection placed in favorites memory 38, which can be as many as desired, but at least one.

If any favorites at all are in favorites memory 38 favorites memory 38 automatically overrides stack pattern memory 24 by activating favorites changeover circuit 26. This circuit is shown schematically by a simple switch, but the action is actually programmed into the on-board computer to monitor favorites memory 38 and use only that memory as the source for control information for the bale wagon if any patterns are stored within it. This simply means that if the favorites are not desired to be used, the list in favorites memory 38 must be deleted.

The invention thereby greatly enhances the existing controls on an automatic bale wagon by permitting the operator to set up a short preferred list of stack patterns, and even without that, to move up and down through the large list of stack patterns in whatever direction is most efficient.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

For example, the described functions can be performed by either the computer already on board an automated bale wagon, or a separate computer or discreet components and controls can be used for the sequence reversal and for the favorites list.

1. In an automated bale wagon with a selection apparatus for electronically selecting a particular stack pattern from a stack pattern list for use by the bale wagon controls and in which a sequencing apparatus steps in one direction to one adjacent value on the list at each activation of a manual control, the improvement comprising:
a timing device interconnected with the manual control and evaluating if the manual control has been activated for at least a specific time interval, and generating an electronic signal when the specific time interval has been exceeded; and
a sequence reversing device interconnected with the timing device and the sequencing apparatus, and upon receiving the electronic signal from the timing device causing the sequencing apparatus to reverse the direction on the list in which the sequencing apparatus steps upon the activation of the manual control.

2. The automated bale wagon of claim 1 wherein the selection apparatus is a computer, and the sequencing apparatus, the timing device, and the sequence reversing device are programmed functions of the computer.

3. The automated bale wagon of claim 1 wherein the manual control is a pushbutton.

4. In an automated bale wagon with a selection apparatus for electronically selecting a particular stack pattern from a stack pattern list for use by the bale wagon controls and in which a sequencing apparatus steps to a new stack pattern on the list at each activation of a manual control, the improvement comprising:
a set-up device to compile a favorites list by selecting individual stack patterns from the stack pattern list and placing the selected individual stack patterns in a favorites memory; and
a favorites changeover device interconnected with the favorites memory and with the manual control and operating to automatically select the favorites memory in place of the stack pattern list upon activation of the manual control when any stack patterns have been placed in the favorites memory.

5. The automated bale wagon of claim 4 wherein the selection apparatus is a computer, and the sequencing apparatus, the set-up device, the favorites memory, and the favorites changeover device are programmed functions of the computer.

6. In a selection apparatus for electronically selecting an item from a list, wherein a sequencing apparatus steps in one direction to one adjacent item on the list at each activation of a manual control, the improvement comprising:
a timing device interconnected with the manual control and evaluating if the manual control has been activated for at least a specific time interval, and generating an electronic signal when the specific time interval has been exceeded; and
a sequence reversing device interconnected with the timing device and the sequencing apparatus, and upon receiving the electronic signal from the timing device causing the sequencing apparatus to reverse the direction on the list in which the sequencing apparatus steps upon the activation of the manual control.

7. The selection apparatus of claim 6 wherein the selection apparatus is a computer and the sequencing apparatus, the timing device, and the sequence reversing device are programmed functions of the computer.

8. The selection apparatus of claim 6 wherein the manual control is a pushbutton.

9. In a selection apparatus for electronically selecting an item from a list in which a sequencing apparatus steps to an item on the list at each activation of a manual control, the improvement comprising:
a set-up device to compile a favorites list by selecting individual items from the list and placing the selected individual items in a favorites memory; and
a favorites changeover device interconnected with the favorites memory and with the manual control and operating to automatically select the favorites memory in place of the list upon activation of the manual control when any items have been placed in the favorites memory.

10. The selection apparatus of claim 9 wherein the selection apparatus is a computer, and the sequencing apparatus, the set-up device, the favorites memory, and the favorites changeover device are programmed functions of the computer.
